(19) United States
(12) Patent Application Publication
(10) Pub. No.: US 2023/0089504 A1
(43) Pub. Date: Mar. 23, 2023

(54) SYSTEM AND METHOD FOR DATA ANALYSIS

(71) Applicant: Ambient AI, Inc., Palo Alto, CA (US)

(72) Inventors: Vikesh Khanna, Palo Alto, CA (US); Shikhar Shrestha, Palo Alto, CA (US)

(21) Appl. No.: 17/941,951

(22) Filed: Sep. 9, 2022

Related U.S. Application Data
(60) Provisional application No. 63/245,575, filed on Sep. 17, 2021.

(51) Int. Cl. G06V 20/52; G06V 10/80; G06V 10/771

(52) U.S. Cl. CPC G06V 20/52; G06V 10/80; G06V 10/771; G06V 2201/10

(57) ABSTRACT

In variants, the method for data analysis can include: determining a measurement set, optionally identifying measurements of interest, selecting measurements to composite, generating composite measurements, analyzing a batch of measurements, and optionally training a policy model.

### CROSS-REFERENCE TO RELATED APPLICATIONS

This application claims the benefit of U.S. Provisional Application No. 63/245,575, filed 17 Sep. 2021, which is incorporated in its entirety by this reference.

### TECHNICAL FIELD

This invention relates generally to the data processing field, and more specifically to a new and useful method for processing more input streams in the data processing field.

### BACKGROUND

It is oftentimes advantageous to dynamically increase the amount of throughput analyzed by analysis models, such as neural networks. This is oftentimes done by increasing the batch size at inference. However, this increased throughput can come at the expense of latency and/or accuracy, which, in real-time use cases, can be extremely detrimental to overall system performance.

Thus, there is a need in the data processing field to create a new and useful system and method to increase throughput with lossless or comparable model performance. This invention provides such a new and useful system and method.

### BRIEF DESCRIPTION OF THE FIGURES

FIG. 1 is a schematic representation of a variant of the method.

FIG. 2 is a schematic representation of a variant of the system.

FIG. 3 is an illustrative example of a variant of the method.

FIG. 4 is an illustrative example of a variant of the method.

FIG. 5 is an illustrative example of a variant of the method.

FIG. 6 is an illustrative example of a variant of the method.

FIG. 7 is an illustrative example of training a policy model.

### DESCRIPTION OF THE PREFERRED EMBODIMENTS

The following description of the preferred embodiments of the invention is not intended to limit the invention to these preferred embodiments, but rather to enable any person skilled in the art to make and use this invention.

### 1. Overview

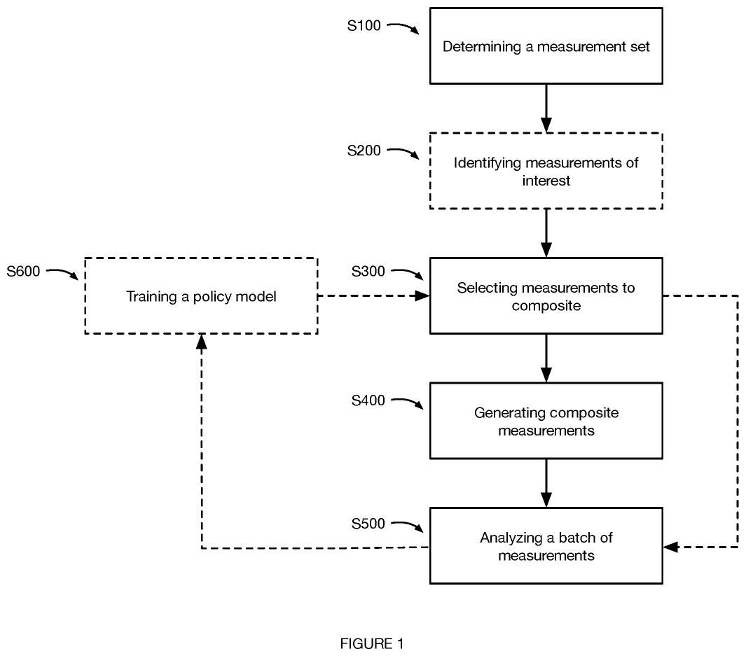

As shown in FIG. 1, variants of the method can include: determining a measurement set S100, optionally identifying measurements of interest S200, selecting measurements to composite S300, generating composite measurements S400, and analyzing a batch of measurements S500. The method can optionally include training a policy model S600. However, the method can additionally and/or alternatively include any other suitable elements.

In variants, the method can function to allow more measurements to be processed using the same processing architecture (e.g., analysis modules), without retraining, hyperparameter adjustment, and/or hardware upgrades, while maintaining the same or similar performance (e.g., recall, precision, accuracy) and/or speed.

### 2. Examples

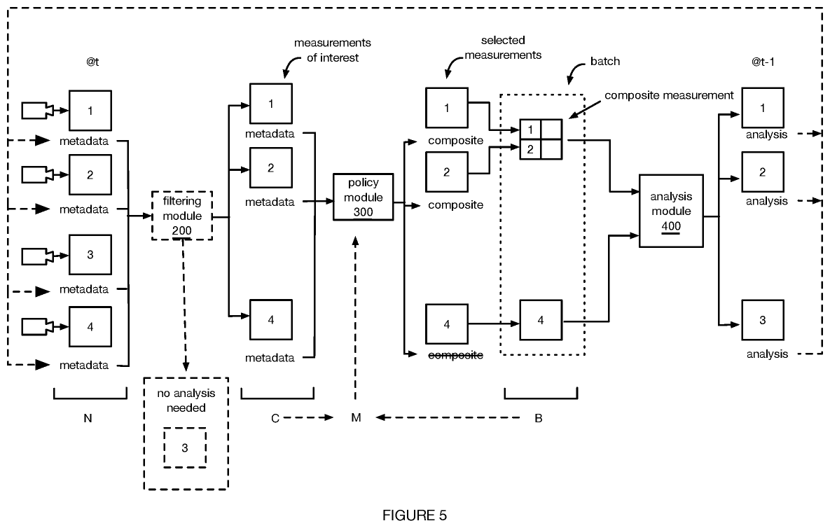

In an illustrative example (example shown in FIG. 5), the method includes: receiving a set of N images; optionally filtering out images satisfying a filtering condition (e.g., amount of activity detected in the scene is less than a predetermined threshold); determining the number of remaining images within the set (C); optionally determining a target batch size (B) for the analysis model; determining a number of images to select for composition (or proportion of the remaining images to composite) based on the number of remaining images (C) and the target batch size for the analysis model (B); selecting up to or at least the number of images from the remaining images; downscaling the selected images; generating a set of composite images (e.g., multiplexed images), each formed from a grid of downscaled images (e.g., grid of 4 downscaled images); optionally batching the composite images and the remaining (uncomposited) images, wherein the resultant batch size (e.g., the target batch size) can be less than the number of original or remaining images (C); and providing the batched images to the analysis model for analysis. The resultant analyses can be used to detect security events, trigger security responses, or otherwise used. In this example, the batch size (B) can be smaller than N, smaller than C, and/or otherwise related to the image set. In specific examples, image filtering and/or image selection for composition can be performed using the metadata associated with the respective image, which can expedite the respective processes. The metadata can include or be determined from analyses of measurements from prior timesteps and/or analysis epochs.

However, the method can be otherwise performed.

### 3. Technical Advantages

Variants of the technology can confer several benefits over conventional systems and methods.

First, variants of the technology can enable a machine with fixed computational resources that is capable of processing only U computational units per unit time to concurrently process more than U computational units per unit time (e.g., N images), while preserving or maximizing the quality of the output at each timestep.

Second, variants of the technology can process more streams using the same analysis model without changing the hyperparameters (e.g., batch size) or retraining, while maintaining the same or similar performance (e.g., accuracy) and speed. In such variants, the method can include: filtering for streams of interest and/or dynamically adjusting the resolution of the streams of interest. In a specific example, variants of the technology can enable a trained neural network model to concurrently process more streams without changing or increasing the batch size. In an example, the method includes compressing (e.g., downscaling) and compositing m images into a composite image (e.g., multiplexed image), wherein the composite image is included as a full-frame image within the batch provided to the trained neural network model(s) for analysis. In this example, the trained neural network model(s) can extract metadata for each constituent image (and respective monitored space and/or scene) within the composite image.

However, the technology can confer any other suitable benefits.

### 4. System

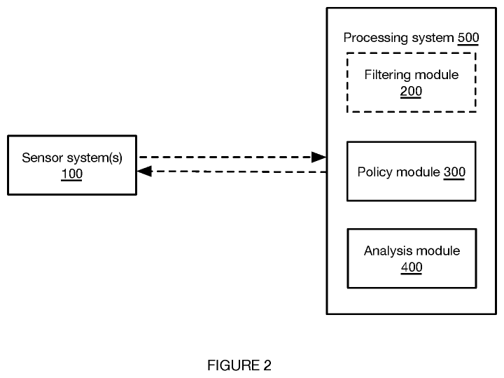

As shown in FIG. 2, variants of the system can include: one or more sensor systems 100, optionally one or more filtering modules 200, one or more policy modules 300, one or more analysis modules 400, and one or more processing systems 500. However, the system can additionally and/or alternatively include any other suitable components.

In variants, the system can function to monitor and analyze a monitored space based on measurements of the monitored space, but can be otherwise used.

A different system instance is preferably used for each monitored space (e.g., monitored physical space); alternatively, the same system instance, and/or component instance, can be used for multiple monitored spaces (e.g., the same processing system can be used to determine safety events for multiple spaces). Examples of monitored spaces can be: schools, malls, museums, hotels, airports, houses, and/or any other suitable spaces. Each monitored space preferably has one or more monitored scenes, but can alternatively have no monitored scenes. Examples of monitored scenes can be: hallways, alleyways, lobbies, main entrances, side entrances, rooms, and/or any other suitable subspaces of the monitored space.

The sensor system 100 can be associated with and/or configured to sample measurements of a monitored scene. The system preferably includes multiple sensor systems 100 (e.g., N sensor systems), but can alternatively include a single sensor system 100, or any other suitable number of sensor systems. The sensor systems 100 within the system are preferably the same, but can additionally and/or alternatively be different. The number of sensor systems 100 is preferably unfixed and/or variable, but can alternatively be fixed (e.g., to B, a multiple of B, less than B, etc.). The sensor systems 100 are preferably distributed within a monitored space (e.g., a physical space), but can alternatively be distributed within multiple monitored spaces, and/or otherwise distributed. The sensor systems 100 can monitor the same monitored scene within a monitored space, monitor different monitored scenes within a monitored space, monitor different monitored scenes within different monitored spaces, and/or otherwise arranged. Each sensor system 100 preferably generates a single measurement time series (e.g., a measurement stream), but can additionally and/or alternatively generate multiple measurement time series, and/or any other suitable number of measurement time series.

Each sensor system 100 can include one or more: cameras (e.g., visual range, multispectral, hyperspectral, IR, stereoscopic, etc.), video cameras, orientation sensors (e.g., accelerometers, gyroscopes, altimeters), acoustic sensors (e.g., microphones), optical sensors (e.g., photodiodes, etc.), temperature sensors, pressure sensors, flow sensors, vibration sensors, proximity sensors, chemical sensors, electromagnetic sensors, force sensors, depth sensors, light sensors, motion sensors, scanners, frame grabbers, satellites (e.g., GPS), and/or any other suitable type of sensor.

Each sensor system 100 can optionally include one or more local analysis models (e.g., executing on onboard, local hardware), such as optic flow, video change detection, motion detection, one or more object classifiers (e.g., binary classifiers that detect the presence of given object; multiclass classifiers that detect presence of one or more objects from an object set; etc.), and/or any other suitable models for other analyses. The local analyses results can be included in the metadata associated with the measurement, and/or be otherwise used.

Each sensor system 100 preferably samples measurements, but can alternatively not sample measurements. The measurements can function as the basis for analysis and/or otherwise used. Examples of measurements can include: videos (e.g., time series of images, image stream, etc.) captured in color; still-images captured in color (e.g., RGB, hyperspectral, multispectral, etc.); videos and/or still-images captured in black and white, grayscale, IR, NIR, UV, thermal, RADAR, LiDAR, and/or captured using any other suitable wavelength; videos and/or still-images with depth values associated with one or more pixels; a point cloud; a proximity measurement; a temperature measurement; and/or any other suitable measurements.

The measurements are preferably local or on-site measurements sampled proximal to the monitored scene and/or space, but can additionally and/or alternatively be remote measurements (e.g., satellite imagery, aerial imagery, etc.). The measurements can include: interior measurements, exterior measurements, and/or any other suitable measurements. The measurements can include: angled measurements, top-down measurements, side measurements, and/or sampled from any other pose and/or angle relative to the monitored scene and/or space. Each measurement can be associated with characteristics, or not be associated with characteristics. Examples of characteristics include: aspect ratio, dimensions, resolution, measurement type, and/or any other suitable characteristic. Each measurement is preferably associated with metadata (e.g., analyses), but can alternatively not be associated with metadata.

Each measurement can be associated with a set of metadata (e.g., values for a set of metadata attribute values). The measurement's metadata can be shared with other measurements, or be specific to the measurement itself. The metadata associated with the measurement is preferably from a prior timestamp or analysis epoch (e.g., historical metadata), but can alternatively be derived from the measurement itself. The metadata from the prior timestamp can include: metadata from the immediately preceding timestamp (e.g., the immediately preceding analysis epoch), metadata from a prior time window (e.g., adjacent or contiguous with the measurement's timestamp; including the immediately preceding timestamp; separated from the measurement's timestamp by a predetermined number of timestamps or analysis epochs; etc.), and/or metadata from any other suitable time. The metadata associated with the measurement can be determined from: prior measurements from the same measurement stream; prior measurements generated by the same sensor (e.g., when the sensor generates multiple measurement streams, the metadata can be derived from the same or different measurement stream); other measurements of the same monitored scene (e.g., the scene monitored by or depicted within the measurement; etc.); and/or any other suitable data.

Each measurement can be: deleted after analysis (e.g., to conserve storage; wherein the extracted analyses can be stored for an extended period of time; etc.), stored for a predetermined period of time, stored persistently, stored if an analysis value extracted from the measurement satisfies a set of retention conditions, and/or otherwise stored.

In variants, the measurements (e.g., raw measurements, full-frame measurements, etc.) can be selectively composited into composite measurements. The composite measurement preferably has the same parameters as the uncomposited measurement (e.g., the full-frame measurement), but can alternatively have different characteristics from the uncomposited measurement. Example characteristics that can be the same (or different) can include: dimensions (e.g., height, width, etc.), resolution, color channels, aspect ratio, measurement type, and/or any other suitable characteristic. Each composite measurement can include one or more constituent measurements (e.g., raw measurements, full-frame measurements). The constituent measurements are preferably arranged in a grid (e.g., regular grid, Cartesian grid, etc.) within the composite measurement, but measurements within the composite measurement can alternatively be randomly arranged or otherwise arranged. The composite measurement preferably has a predetermined grid size (e.g., predetermined cell size; hold a predetermined number of constituent measurements; etc.), but can alternatively have a variable grid size (e.g., wherein the measurements are dynamically scaled to fit within the composite measurement). The constituent measurements are preferably uniformly downscaled to fit within a grid cell of the composite measurement, such that the full frame of the constituent measurement is preserved (e.g., albeit with less resolution), but can alternatively be cropped or otherwise reduced in size to fit within the grid cell.

The constituent measurements within the composite measurement are preferably associated with a region identifier identifying a region within the composite measurement, such that the analysis extracted from that region of the composite measurement can be mapped back to the constituent measurement; alternatively, the position of the constituent measurements within the composite measurement can be unidentified and/or untracked. Examples of region identifiers include: grid position (e.g., first cell, second cell, third cell, fourth cell, etc.); pixel boundaries (e.g., from (0,0) to (50,64), etc.); and/or any other suitable region identifier. The region identifiers can be assigned to the constituent measurements when the measurements are being composited or be assigned at any other suitable time. Additionally or alternatively, each composite measurement regions can be associated with the measurement stream identifier, sensor system identifier, monitored space identifier, monitored scene identifier, and/or other identifier associated with the constituent measurement located within said region, wherein analyses of said region are associated with the respective measurement stream, sensor system, monitored space, monitored scene, and/or other system.

However, the composite measurements can be otherwise configured.

Each sensor system 100 is preferably associated with a set of measurement streams, but can alternatively not be associated with a set of measurement streams. The measurement stream is preferably a time series of measurements from the same sensor system 100, but can additionally and/or alternatively be a time series of measurements from different sensory systems 100, multiple time series of measurements from the same sensor system 100, and/or otherwise be defined. Additionally and/or alternatively, the measurement stream can include measurements from associated secondary sensor systems (e.g., a motion sensor monitoring the same scene, optionally from the same pose, as the primary sensor).

In variants, the measurement stream, sensor system 100, monitored space, monitored scene, and/or other element can also be associated with a set of metadata. The metadata associated with each of these elements is preferably derived from measurements within, generated by, or generated for (e.g., depicting, monitoring, etc.) the element, but can additionally or alternatively be derived from measurements from other elements. For example, the metadata for the measurement stream can be generated from measurements of the measurement stream; the metadata for the sensor can be generated from measurements sampled by the sensor; and the metadata for the monitored space can be generated from measurements of the monitored space.

However, the sensor system 100 can be otherwise configured.

The system can include one or more modules configured to: process measurements (e.g., from the measurement set, from the measurements of interest), determine which measurements to composite, determine analyses, perform all or portions of the method, and/or perform any other suitable functionalities. The system can include one or more modules of the same or different type. The system can include one or more modules of the same or different type. The modules can be or include: a neural network (e.g., CNN, DNN, etc.), an equation (e.g., weighted equations), a random generator, leverage regression, classification, rules, heuristics, instance-based methods (e.g., nearest neighbor), regularization methods (e.g., ridge regression), decision trees, Bayesian methods (e.g., Naïve Bayes, Markov, etc.), kernel methods, probability, deterministics, support vectors, and/or any other suitable model or methodology. The modules can be trained using reinforcement learning, supervised learning, unsupervised learning, semi-supervised learning, and/or any other suitable learning technique.

The modules of the system can include one or more: filtering modules 200, policy modules 300, analysis modules 400, and/or any other suitable modules. All or a portion of the modules can be executed: locally on a sensor system 100, by the same or different centralized processing system (e.g., processing system 500), by a decentralized processing system, and/or by any other suitable computing system.

The system can optionally include one or more filtering modules 200 configured to determine measurements of interest from a measurement set. The filtering modules can be executed: on each sensing system 100, on the computing system executing the policy module, on the computing system compositing the measurements, on the computing system performing the analyses, on a separate computing system from those mentioned above, and/or by any other suitable computing system.

Each filtering module 200 can include one filtering model, multiple filtering models, and/or any other suitable number of filtering models. The filtering model can be a heuristic model, a trained model, an untrained model, and/or any other suitable model. The filtering model can be a change filter, a motion filter and/or detector, a binary threshold filter that includes or excludes measurements from the measurement set based on whether respective metadata values satisfy a predetermined threshold and/or condition, and/or any other suitable model. In an example, the filtering module is a change and/or motion filter and/or detector used to filter out measurements with less than a threshold amount of change and/or motion in the monitored scene (e.g., between the current measurement and one or more preceding measurements). In a second example, the filtering module randomly selects which measurements to filter in or out. In a third example, the filtering module includes a counter (e.g., for each measurement stream, each sensor, etc.), and filters in measurements from measurement streams that have had a predetermined number of prior measurements (e.g., within a predetermined time frame) filtered out. However, the filtering module 200 can be otherwise configured.

The filtering module 200 is preferably generic across monitored spaces and/or scenes, but can additionally and/or alternatively be specific to: a monitored space and/or scene, a geographic region (e.g., a continent, a country, a state, a county, a city, a zip code, a street), a sensor system 100, an object (e.g., a human, a weapon, etc.), an inference batch size B, a policy module 300, an analysis module 400, and/or be otherwise specific.

However, the filtering module 200 can be otherwise configured.

The system can include one or more policy modules 300 configured to determine which measurements to composite and/or not composite (e.g., select the measurements to include in the composited subset and/or uncomposited or full-frame subset, respectively).

The policy module 300 preferably determines which measurements to composite and/or not composite for each analysis epoch or epoch of measurements (e.g., wherein an epoch of measurements can be contemporaneously or concurrently sampled), but can additionally or alternatively determine which measurements to composite and/or not composite across multiple epochs. In a first example, the policy module 300 selects which measurements to composite from a set of contemporaneously-sampled measurements. In a second example, the policy module 300 selects which measurements to composite from a set of measurements sampled across a time window (e.g., encompassing one or more measurement epochs). The policy module 300 is preferably executed at the analysis frequency and/or measurement sampling frequency, but can additionally or alternatively be executed at any other suitable frequency.

The policy module 300 is preferably executed on a centralized processing system that receives the measurement streams, but can additionally or alternatively be executed on each sensing system 100, on a distributed system, and/or on any other suitable computing system.

The policy module 300 can determine which measurements to composite and/or not composite based on: a batch size for the analysis model(s); a number of candidate measurement streams (e.g., before or after filtering with the filtering module); the metadata for each measurement; a user preference; and/or based on any other suitable data. The metadata for each measurement is preferably the metadata associated with the measurement's measurement stream (e.g., the measurement stream from which the measurement was received; the measurement stream the that measurement is a part of), but can additionally or alternatively be associated with the originating sensor system 100 (e.g., the sensor sampling the measurement), the monitored scene (e.g., depicted in the measurement; associated with the measurement; etc.), a shared measurement epoch with the measurement (e.g., contemporaneous auxiliary data), and/or any other data. Each policy module 300 can include one policy model, multiple policy models, and/or any other suitable number of policy models. The same policy model can be used for each analysis model; alternatively, different policy models can be used for each analysis model. The policy model can be: manually determined, be a trained or learned model, be an untrained model, and/or be any other suitable model. The policy model is preferably a lossless affinity function (e.g., substantially maintains the attribute extraction accuracy, precision, and/or speed), but can additionally and/or alternatively be a set of rules and/or heuristics, a random generator, a neural network, and/or any other suitable model. In an example, the policy model can select measurements for composition such that the set of attributes for each measurement that are extracted using the composited measurement set (e.g., including both composited measurements and other, uncomposited measurements) is substantially the same as the set of attributes for each measurement that is extracted using the full-frame measurements (e.g., within a margin of error, such as 10%, 5%, 3%, 2%, 1%, 0.5%, etc.). However, a lossless affinity function can be otherwise defined.

The policy module 300 can be specific to: a monitored space and/or scene, a geographic region (e.g., a continent, a country, a state, a county, a city, a zip code, a street), a sensor system 100, an object (e.g., a human, a weapon, etc.), an inference batch size B, a filtering module 200, an analysis module 400, an entity, a recurrent timeframe (e.g., day of week, month of year, season, etc.), a metadata parameter set, and/or be otherwise specific. Additionally and/or alternatively, the policy module 300 can be generic among: monitored spaces and/or scenes, geographic regions, sensor systems 100, objects, inference batch sizes, filtering modules 200, analysis modules 400, entities, recurrent timeframes, metadata parameter sets, and/or be otherwise generic.

The same policy module 300 is preferably used to select composited and/or uncomposited measurements from all measurement streams of a monitored space and/or scene, but alternatively different policy modules 300 can be used to select composited and/or uncomposited measurements from all measurements streams of a monitored space and/or scene. The policy module 300 can prioritize more recent information (e.g., metadata) over less recent information.

However, the policy module 300 can be otherwise configured. The system can include one or more analysis modules 400 configured to extract attributes (e.g., metadata attributes; etc.) or otherwise analyze each measurement. The attributes and/or derivative analyses thereof can be used to detect security events, used as metadata (e.g., measurement metadata), and/or otherwise used. Each analysis module 400 can include one analysis model, multiple analysis models, and/or any other suitable number of analysis models. The analysis model is preferably a trained model, but can alternatively be an untrained model. The analysis model can be a neural network, a set of equations (e.g., a bundle adjustment, a set of regressions, etc.), a classifier (e.g., binary, multiclass), regression, a heuristic, a ruleset, and/or any other suitable model. The analysis model can be: a single network, a cascade of networks, a neural network ensemble, and/or otherwise constructed.

The analysis model preferably includes an object detector (e.g., configured to detect: doors, weapons, humans, animals, containers such as backpacks or bags, etc.), a pose detector, and/or event detector, but can additionally and/or alternatively include facial recognition, scene segmentation, object attribute detection, security event detection, time series tracking (e.g., tracking the extracted attribute values over time), and/or any other suitable functionality. The analysis model can be a binary classifier, multiclass classifier, semantic segmentation model, instance-based segmentation model, and/or any other suitable model. In examples, the analysis model be a model as discussed in U.S. application Ser. No. 16/137,782 filed 21 Sep. 2018; U.S. application Ser. No. 16/816,907 filed 12 Mar. 2020; U.S. application Ser. No. 16/696,682 filed 26 Nov. 2019; U.S. application Ser. No. 16/695,538 filed 26 Nov. 2019; each of which are incorporated in its entirety by this reference.

Each analysis model can be trained to determine one or more attribute values (e.g., security analyses) based on a given input. The input is preferably a measurement frame, but can alternatively include multiple measurement frames, attribute values from other attribute models, metadata (e.g., from the same or different analysis epoch), and/or any other suitable data. The measurement frame can include one full-frame measurement (e.g., wherein a single measurement encompasses the entirety of the measurement frame), multiple measurements (e.g., wherein multiple measurements are composited into a measurement frame), and/or any other number of measurements.

The attribute values can be: binary values, continuous values, discrete values, labels (e.g., classes), and/or any other suitable value. The attribute values can include values (e.g., descriptions, labels, counts, etc.) for: objects of interest (e.g., “person”, “gun”, “bag”, “door”, etc.), object attributes (e.g., colors, dimensions, etc.), interactions of interest (e.g., “touching”, “holding”, “near” “approaching”, “walking”, etc.; walking velocity, walking acceleration, estimated trajectory, etc.), states of interest (e.g., “open”, “closed”), multi-object interactions (e.g., “person near bag”, “door open”, etc.), security events (e.g., “class 1 security event detected”, “shooter”, etc.), and/or other values. Examples of attribute values can include: object detections; inter-object interactions; an activity; an object (e.g., person, car, box, backpack); a handheld object (e.g., knife, firearm, cellphone); a human-object interaction (e.g., holding, riding, opening); a scene element (e.g., fence, door, wall, zone); a human-scene interaction (e.g., loitering, falling, crowding); an object state (e.g., “door open”); and an object attribute (e.g., “red car”); security events; and/or values for any other attribute.

The attribute values can be determined for each pixel (or set thereof) in the measurement frame, be determined for the measurement frame as a whole, and/or be determined for any other suitable portion of the frame. In a first example of the former variant, the analysis model can determine whether each pixel set in a measurement frame depicts an object of interest (e.g., “person”, “gun”, “bag”, etc.), interaction of interest (e.g., “touching”, “holding”, “near” “approaching”, “walking”, etc.), state of interest (e.g., “open”, “closed”), event of interest (e.g., “person near bag”, “door open”, etc.), or other attribute of interest. In this example, the analysis model can be a segmentation model, an instance-based segmentation model, and/or any other suitable model. In a second example of the former variant, the analysis model can determine whether an attribute of interest is depicted within each segment of the measurement frame (e.g., each quadrant, etc.). In an example of the latter variant, the analysis model can determine whether an attribute of interest is depicted within the measurement frame as a whole. In these two examples, the analysis model can be a classifier (e.g., binary classifier specific to the attribute class; multiclass classifier trained to determine values for multiple attribute classes; etc.), an object detector, and/or any other suitable model.

Each analysis model can be trained using the same or different training set. In an example, the training set can include a set of measurements (e.g., full-frame measurements, composited measurements, etc.), each labeled with a set of known attribute values. However, any other training set can be used. The analysis models can be trained using supervised learning, unsupervised learning, zero-shot or single-shot learning, reinforcement learning, optimization and/or any other suitable learning technique.

Each analysis model is preferably trained, tuned, optimized (e.g., for a performance metric, such as accuracy, recall, etc.), and/or otherwise determined using a training batch size (e.g., using batch gradient descent, mini batch gradient descent, etc.) to obtain a predetermined set of performance metrics (e.g., latency, accuracy), but can alternatively be trained using any other suitable set of hyperparameters (e.g., learning rate, pooling size, etc.). The batch size and/or other hyperparameter values are preferably the same across all analysis models within the analysis module, but can alternatively be different. The training batch size is preferably fixed but can alternatively be variable. The analysis model preferably accepts an input having an inference batch size (e.g., number of measurements) (B) (e.g., to maintain the model accuracy or speed), but can additionally and/or alternatively accept more or less inputs, have a fixed number of inlet heads, and/or be otherwise configured. The batched inputs can be: concurrently accepted by the analysis model (e.g., at one or more input heads); received for an iteration (e.g., wherein the analysis model serially processes all inputs within the batch before halting or updating the model's internal parameters); and/or otherwise received or processed. The batch size used during inference can be the training batch size (e.g., wherein the model can be trained using a mini batch update or a batch update), a predetermined batch size, optimal batch size, the batch size that is known to confer the desired performance metrics, a dynamically-determined batch size, and/or other target batch size. The inference batch size can be determined based on an optimization, calculated, manually specified, and/or otherwise determined. The inference batch size can be determined to minimize the overall number of overall full-frame measurements analyzed, to maximize the detection accuracy, to minimize accuracy loss (e.g., relative to full-frame analysis), to minimize the inference time for the batch, and/or to achieve any other suitable goal or combination thereof. The batch size used during inference is preferably fixed (e.g., does not vary between iterations or instances of the method), but can alternatively be unfixed and/or variable (e.g., based on the number of inputs, performance requirements, dynamically determined, etc.). The measurements within the batch are preferably contemporaneously sampled (e.g., concurrently sampled, sampled within the same sampling time window or epoch, sampled at substantially the same timestamp, etc.), but can additionally or alternatively be sampled asynchronously (e.g., at different timestamps, during different time windows or epochs, etc.), and/or be otherwise temporally related. The measurements within the batch can be from the same monitored scene (e.g., same room, same viewing angle, etc.), from the same overall monitored space (e.g., the same building), from spaces associated with the same entity (e.g., multiple factories owned by the same entity), from spaces associated with different entities, and/or be otherwise related or unrelated.

The analysis module 400 can be specific to: a monitored space and/or scene, a geographic region (e.g., a continent, a country, a state, a county, a city, a zip code, a street), a sensor system 100, an object (e.g., a human, a weapon, etc.), an inference batch size B, a filtering module 200, a policy module 300, an entity, a recurrent timeframe (e.g., day of week, month of year, season, etc.), and/or be otherwise specific. Additionally and/or alternatively, the analysis module 400 can be generic among: monitored spaces and/or scenes, geographic regions, sensor systems 100, objects, inference batch sizes, filtering modules 200, policy modules 300, entities, recurrent timeframes, and/or be otherwise generic.

However, the analysis module 400 can be otherwise configured.

However, the modules of the system can be otherwise configured.

The system can be used with a set of metadata, which functions to provide computational and/or semantic representations of the monitored scene. The metadata can additionally or alternatively be used to: detect security events within a monitored scene; select measurements for analysis exclusion, composition, or full-frame analysis; to provide semantic explanations of the scene; and/or otherwise used.

The metadata can include or be determined based on: attribute values determined by the analysis module(s) 400 (e.g., security analyses; semantic primitives; external system primitives; access system primitives, etc.); external or auxiliary data (e.g., weather, social media posts, etc.); the measurement stream's composition history (e.g., whether a prior measurement from the measurement stream and/or sensor system 100 was selected for the last analysis epoch and/or the last E analysis epochs); and/or any other suitable information.

The metadata can be generated: by the analysis module(s) 400 (e.g., wherein the metadata includes security analyses determined using measurements from prior timesteps(s)); by a sensor system 100 (e.g., when the sensor system includes onboard analytics); by auxiliary systems (e.g., access-credentialing systems, such as keycard systems; door sensors; etc.); by a secondary sensor system associated with the sensor system 100; from external data (e.g., weather, social media posts, etc.); and/or otherwise generated.

The metadata can be generated from: one measurement, multiple measurements, and/or any other suitable number of measurements. The metadata can be generated from: measurements from the same stream and/or sensor system 100, measurements from different streams and/or sensor systems 100, previously-determined metadata values, signals from auxiliary systems, and/or generated from any other suitable measurements.

The metadata is preferably associated with the timestep of the measurement from which the metadata was determined, but can additionally and/or alternatively be associated with any other suitable timestep.

In a first variant, the metadata can include the amount of motion detected by the sensor system 100.

In a second variant, the metadata can include contemporaneously-determined information from an auxiliary source associated with the measurement. Examples of auxiliary sources include: other sensors within the sensor system 100 (e.g., accelerometers, etc.); another measurement monitoring the same scene; external sources (e.g., weather, social media sources, etc.); and/or any other auxiliary source.

In a third variant, the metadata can include the security analyses generated by the analysis modules 400 from a prior timestep. The prior timestep and/or set thereof (e.g., prior time window) that is used can vary for each metadata attribute, vary based on the metadata attribute's values, be predetermined, vary based on the policy module, and/or otherwise determined.

In a first embodiment of the first variant, the metadata can include short term metadata (e.g., short term history). Short term metadata can include: metadata values from the immediately preceding analysis epoch (e.g., timestep, measurement epoch, etc.); metadata values from an immediately preceding time window (e.g., including one or more analysis epochs); metadata values from analysis epochs within a predetermined time frame (e.g., last 1 second, 30 seconds, 1 minute, 10 minutes, etc.), and/or metadata values from any other suitable time period.

In a second embodiment of the first variant, the metadata can include long term metadata (e.g., long term history).

In a first example, long-term metadata includes metadata values from a prior time window, wherein the prior time window can be adjacent to or separated from the current timestamp. In an illustrative example, long term history includes metadata determined from all measurements (e.g., from the same measurement stream, from the sensor system 100, from the monitored scene, etc.).

In a second example, long-term metadata includes metadata values from analysis epochs within a predetermined time frame (e.g., metadata determined within the last day, month, 3 months, year, etc.).

In a third example, long-term metadata includes one or more summaries of the prior metadata values (e.g., from an unlimited time window or a limited time window relative to the current time). Examples of summaries that can be included include: the mean, median, or mode for each metadata attribute; the standard deviation for each metadata attribute; the frequency of occurrence for each metadata attribute value (e.g., baseline frequency); a count (e.g., of unique attribute values; of instances for each attribute value; etc.); frequency (e.g., baseline); histogram; histogram feature (e.g., first derivative, second derivative, etc.); and/or any other summary of the metadata. In an illustrative example, long term history includes a baseline per metadata attribute (and/or subset of metadata attributes). The baseline can be a frequency of a given metadata attribute value, an average of the values for a metadata attribute, and/or any other higher-level analysis for each metadata attribute and/or combination thereof. The baseline can be determined across a timeframe, wherein the timeframe can: vary for each metadata attribute, vary based on the metadata attribute's values, be predetermined, and/or otherwise determined.

In a fourth example, long-term metadata includes derivatory metadata (e.g., derived from multiple metadata attributes) and/or summaries thereof. In an illustrative example, long-term metadata can include the frequency at which a specific combination of metadata attribute values (e.g., “person holding a gun”) occurs.

However, the metadata can include a combination of the above and/or any other suitable information associated with the monitored scene.

Each piece of metadata can be associated with: one or more measurements (e.g., from which the metadata was derived), one or more measurement streams (e.g., from which the measurements were derived; etc.), one or more sensor systems 100 (e.g., that generated or sampled the measurement streams; a sensor instance; a sensor type; etc.), one or more monitored scenes (e.g., that the sensor systems 100 were monitoring; that the measurements depicted; etc.), an entity associated with the monitored space and/or scene, a measurement time (e.g., metadata from a time window encompassing or determined based on the measurement timestep), and/or any other suitable data object, system, and/or information. The processing system 500 is configured to perform all or portions of the method. The processing system 500 can additionally detect security events (e.g., as discussed in U.S. application Ser. No. 16/137,782 filed 21 Sep. 2018; U.S. application Ser. No. 16/816,907 filed 12 Mar. 2020; U.S. application Ser. No. 16/696,682 filed 26 Nov. 2019; U.S. application Ser. No. 16/695,538 filed 26 Nov. 2019; each of which are incorporated in its entirety by this reference), generate user interfaces, and/or perform any other suitable functionalities. The processing system 500 can be an on-premises system (e.g., collocated with the sensor systems 100, located within the monitored space, etc.); remote from the monitored space; or otherwise arranged relative to the monitored space. The processing system 500 can include one or more CPUs, GPUs, microprocessors, servers, cloud computing, distributed computing, and/or any other suitable components. The processing system 500 can be connected to each of the sensor systems 100 by a wireless or wired connection (e.g., a network switch). In a specific example, the processing system 500 and set of sensor systems 100 cooperatively form a closed-circuit television system (e.g., with or without a television or other user interface). However, the processing system 500 and set of sensor systems 100 can cooperatively form an open-circuit television system.

However, the processing system 500 can be otherwise configured.

### 5. Method

The method can function to allow more measurements to be processed using the same processing architecture (e.g., analysis modules), while maintaining the same or similar performance (e.g., recall, precision, accuracy) and speed.

A different method instance is preferably used for each monitored space; alternatively, the same method instance can be used for multiple monitored spaces (e.g., the same processing system 500 can be used to determine safety events for multiple spaces).

A different instance of the method is preferably performed for each timestep or each analysis epoch. Alternatively, each instance can span multiple timesteps or analysis epochs, or multiple instances of the method can be run in series or in parallel for each timestep or analysis epoch. Each method instance preferably processes measurements sampled during the same time step or analysis epoch, but can alternatively process measurements from other timesteps or analysis epochs. Timesteps and/or analysis epochs can be: <0.001 seconds, 0.001 seconds, 0.01 seconds, 0.1 seconds, 1 second, 10 seconds, 100 seconds, >100 seconds, within a range bounded by any of the aforementioned values, and/or any other suitable time period.

All or portions of the method are preferably performed in real- or near-real time (e.g., within a predetermined time period from measurement sampling), but can additionally and/or alternatively be performed asynchronously. All or portions of the method are preferably performed by the processing system 500, but can additionally and/or alternatively be performed by any other suitable system.

### 5.1. Determining a Measurement Set S100.

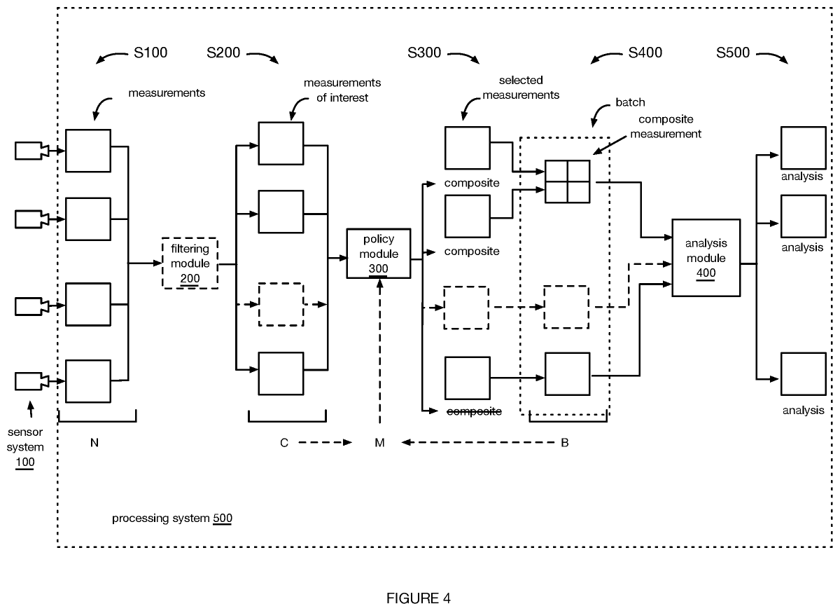

Determining a measurement set S100 can function to obtain information about the monitored scenes for subsequent analysis. S100 is preferably performed before S200, but can additionally and/or alternatively be performed concurrently with S200, after S200, and/or any other suitable time. S100 can be performed by: the sensor system 100, the filtering module 200, the policy module 300, the analysis module 400, the processing system 500, and/or any other suitable system. The measurement set preferably includes a measurement from each sensor system 100 of the system (e.g., N measurements from N systems; example shown in FIG. 4; etc.), but can alternatively include more or less measurements. Each measurement of the measurement set is preferably a measurement as described above, but can additionally and/or alternatively be any other suitable measurement. The measurements within the measurement set can all have the same characteristics (e.g., aspect ratio, dimensions, resolution, measurement type, etc.), but can additionally and/or alternatively have different characteristics. The number of measurements within the measurement set is preferably unfixed and/or variable, but can alternatively be fixed (e.g., limited to a predetermined number of measurements). Each measurement of the measurement set can be associated with a measurement identifier or not be associated with a measurement identifier. The measurements within the measurement set are preferably from the same sampling epoch (e.g., the same time step, same analysis epoch, contemporaneously sampled, concurrently sampled, etc.), but can alternatively be from different sampling epochs (e.g., sequential sampling epochs, non sequential sampling epochs, etc.).

However, the measurement set can be otherwise determined.

S100 can optionally include pre-processing the measurement set to consolidate the measurement characteristics. Pre-processing the measurement set can be performed by: the sensor system 100, the filtering module 200, the policy module 300, the analysis module 400, the processing system 500, and/or any other suitable system. Pre-processing the measurement set can include: cropping, resizing, infilling, adjusting (e.g., adjusting the exposure and/or contrast), and/or otherwise process the measurement set. However, the measurement set can be otherwise pre-processed.

S100 can optionally include determining metadata for each measurement. The metadata is preferably associated with a timestep and/or analysis epoch, but can additionally and/or alternatively not be associated with a timestep and/or analysis epoch, associated with a timestamp, and/or any other suitable time. The metadata is preferably determined during a prior timestep and/or analysis epoch, but can additionally and/or alternatively be determined during the current timestep and/or analysis epoch, and/or otherwise determined. Examples of metadata can include: the measurement characteristics (e.g., aspect ratio, resolution, point density, etc.), whether motion was detected, motion amount, timestamp, sensor identifier, external values (e.g., associated calendar events for the monitored space and/or scene, social media analyses, etc.), the analysis values (e.g., primitives) from a prior timestep (e.g., from the same measurement stream, sensor system 100, monitored space and/or scene, measurement set, etc.), and/or any other suitable metadata. Examples of analysis values that can be included in the metadata include: whether an object was detected, detected object class, object identifier (e.g., vehicle ID), object attribute, whether a human was detected, human pose class, human identifier (e.g., fingerprint ID, person ID, etc.), whether an activity was detected, detected activity class, interactions (e.g., between detected objects, entities, and/or humans), change across frames (e.g., sitting down to standing up), measurement stream history (e.g., short term history, such as within the last 30 s, 1 min, 10 mins, etc.; long term history, such as the last day, month, 3 months, year, etc.), historical patterns (e.g., minimum, maximum, average, or other statistical summary of the number of incidents detected from the measurement stream for a given time of day, day of week, week of year, etc.), scene history (e.g., short term history, long term history, etc.), security event history (e.g., short term history, long term history, etc.), reappearance of agents (e.g., users, vehicles, entities, etc.) on physically and/or temporally adjacent measurement streams, agent parameters (e.g., extracted from the measurement stream, etc.), sensor context (e.g., physical location, monitored object or region class, etc.), scene type or environmental context (e.g., kitchen, front door, back door), ambient environment changes (e.g., lighting change exceeding a threshold, acoustic change exceeding a threshold, etc.), and/or other suitable metadata.

In a first variant, determining metadata for each measurement can include retrieving previously-determined metadata for the measurement stream (e.g., that the measurement is part of). The metadata is preferably determined by the analysis module 400, but can additionally and/or alternatively be determined by the sensor system 100, the processing system 500, and/or any other suitable system. The metadata is preferably analysis results determined by the analysis module 400, but can additionally and/or alternatively be measurements, measurement characteristics, and/or any other suitable information. The metadata is preferably determined from one or more prior measurements (e.g., measurements associated with a prior timestep and/or analysis epoch), but can additionally and/or alternatively be determined from the measurement itself (e.g., from the measurement set determined in S100), and/or otherwise determined.

In a second variant, determining metadata for each measurement can include receiving metadata from the sensor system 100 sampling the measurement (e.g., based on the source sensor system identifier).

In a third variant, determining metadata for each measurement can include determining metadata from the measurement itself. The metadata can be determined by one or more metadata extraction modules executed by the processing system 500 based on the measurement.

However, the metadata for each measurement can be otherwise determined.

### 5.2. Identifying Measurements of Interest S200.

Identifying measurements of interest S200 can function to reduce the number of measurements to analyze in S500. S200 is preferably performed after S100 and before S300, but can additionally and/or alternatively be performed before S100, currently with S100, concurrently with S300, after S300, not be performed, and/or performed at any other suitable time. S200 is preferably performed by the filtering module 200, but can additionally and/or alternatively be performed by the policy module 300, the analysis module 400, the processing system 500, and/or any other suitable system. The measurements of interest are preferably determined from the measurement set in S100, but can additionally and/or alternatively be determined from a different set of measurements, and/or any other suitable set of measurements. A measurement of interest can be a measurement that has an above-threshold probability of depicting information indicative of an event of interest (e.g., security event, motion and/or change detected, etc.); a measurement associated with a predetermined set of metadata and/or measurement values (e.g., prior metadata values, metadata values from the measurement, other concurrently-sampled measurements, etc.); and/or be otherwise defined. The measurements can be identified based on: their respective metadata (e.g., analysis values from prior timestamps), the measurement's values (e.g., whether the measurement includes a channel value above a threshold), a comparison between the measurement and a prior measurement (e.g., scene change, motion detected, etc.), a comparison between the measurement and a reference (e.g., a mask representative of no attributes of interest depicted in the measurement), the context associated with the source sensor system 100 (e.g., measurements of an entryway are more frequently included in the resultant set and measurements of a drain pipe are less frequently included in the resultant set, etc.), time or number of analysis epochs since measurements from the source sensor system 100 were run (e.g., analyzed) at full resolution (e.g., wherein the probability of analyzing a measurement at full resolution increases with time since a prior measurement from the same stream was analyzed at full resolution), and/or any other suitable parameters.

The filtering module 200 can be a binary threshold filter that includes or excludes measurements from a filtered set based on whether the respective measurement and/or metadata value satisfies a predetermined threshold or condition, or otherwise filter the measurement set. The inclusion or exclusion parameters (e.g., filtering parameters, filtering conditions, etc.) can be specified: automatically; based on the use case (e.g., motion detection for a security system); based on the sensor system's environmental context (e.g., motion detection for streams from a camera monitoring an interior environment; object detection for streams from a camera monitoring an external environment); manually; or otherwise determined. In a first example, an activity filter is used to filter out measurements with less than a threshold amount of motion in the monitored scene. In a second example, the filtering module 200 can retain measurements that have changed between timesteps and/or filter out measurements that have not changed between timesteps (e.g., by comparing hashes of images output by the same sensor system 100).

However, the measurements of interest can be otherwise identified.

### 5.3. Selecting Measurements to Composite S300.

Selecting measurements to composite S300 can function to pick a subset of the (resultant) measurement set for composition (e.g., multiplexing). S300 is preferably performed after S200, but can additionally and/or alternatively be performed concurrently with S200, before S200, and/or any other suitable time. S300 is preferably performed for each analysis epoch (e.g., for each measurement set), but can alternatively be performed for intermittent analysis epochs (e.g., wherein subsequent measurements from the selected set of measurement streams are composited until S300 is performed again), and/or performed at any other frequency. S300 is preferably performed by a policy module 300, but can additionally and/or alternatively be performed by an analysis module 400, a filtering module 200, a sensor system 100, a processing system 500, and/or any other suitable system. The measurements can be selected from the resultant measurement set (e.g., measurements of interest from S200), the measurement set (e.g., measurement set from S100) received from the sensor systems 100, and/or from any other suitable set of measurements. The measurements are preferably selected based on the respective metadata values (e.g., example shown in FIG. 5), but can additionally and/or alternatively be selected based on no information (e.g., randomly selected), based on the respective measurement value, based on a set of conditions (e.g., heuristics) and/or selected based on any other suitable data. A specific number of measurements is preferably selected (e.g., from S100 or S200) for composition, but additionally and/or alternatively all measurements (e.g., from S100 or S200) can be selected for composition, no measurements can be selected for composition, and/or any other suitable number of measurements.

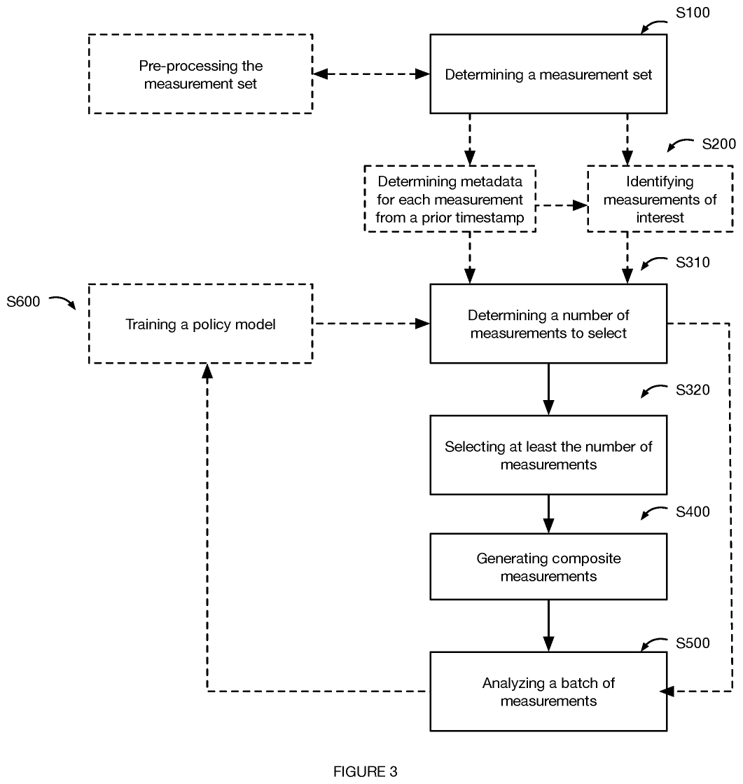

S300 can include: determining a number of measurements to select S310, and selecting at least the number of measurements S32o; example shown in FIG. 3.

Determining a number of measurements to select S310 can function to determine the minimum number of measurements required to satisfy the analysis model's batch size, to achieve a target detection accuracy, to decrease the number of images that are analyzed (e.g., in a batch), and/or for any other suitable reason. The number of measurements to select can: dynamically vary across analysis epochs and/or timesteps (e.g., based on the number of measurements of interest in S200), be unfixed, or be fixed. The number of measurements to select can be: <10 measurements, 10 measurements, 100 measurements, 1000 measurements, >1000 measurements, within a range bounded by any of the aforementioned values, and/or any other suitable number of measurements.

In a first variant, the number of measurements to select is calculated based on the number of measurements of interest (C), the batch size (B), and/or the number of constituent measurements within a composite measurements (g):

C=g*M*B+(1−M)*B, where:

M is the proportion of batch inputs that should be composited measurements; g is the number of constituent measurements within a composite measurement; and g*M*B is the number of measurements to select for composition. M can be calculated (e.g., based on fixed B, fixed g, and C determined from S200), fixed, or otherwise determined. In an illustrative example, for a set of 80 measurements of interest, a target batch size of 32, and a grid value of 4 (e.g., 4 measurements cooperatively form each composited measurement), M can be 50%, such that 64 of the measurements are composited to form 16 composite measurements. The 16 composite measurements, together with the 16 uncomposited measurements, cooperatively form a batch of 32 measurements for analysis model ingestion.

In a second variant, the number of measurements to select is predetermined and/or fixed.

In a third variant, the number of measurements to select is based on the computing hardware performance (e.g., GPU performance). For example, the number of measurements to select can be looked up based on the current % GPU and/or % CPU, current memory used, current energy used, number of processes running, and/or any other suitable parameters. In another example, the number of measurements to select is directly proportional to hardware performance (e.g., number of measurements to select can increase when hardware performance is higher and decrease when hardware performance is lower, wherein the number of measurements can be calculated, iteratively determined, or otherwise determined).

In a fourth variant, the number of measurements to select is determined based on the number of sensor systems, sensor streams, input channels, and/or any other suitable information.

In a fifth variant, the number of measurements to select is determined based on performance of the policy model (discussed below) and/or analysis model. In this variant, the number of measurements to select can be decreased when the performance decreases below a threshold metric, increased when the performance increases above a different threshold metric, and/or otherwise adjusted based on the performance.

In a sixth variant, the number of measurements to select is randomly determined (e.g., using a random generator).

However, the number of measurements to select can be otherwise determined.

Selecting at least the number of measurements S320 can function to select individual measurements to be composited. The system can select: the minimum number of measurements required to satisfy the analysis model's batch size (e.g., determined based on the equation C=g*M*B+(1−M)*B), less than the minimum number of measurements required to satisfy the analysis model's batch size, more than the minimum number (e.g., a multiple of the number of grids in a composite measurement), a predetermined number of measurements, and/or any other suitable number of measurements. Measurements can be evaluated and selected individually (e.g., until the minimum number of measurements is reached); evaluated in a batch, then selected based on the evaluation; and/or evaluated and selected in any other suitable order. In variants of the method including S200, the number of selected measurements can dynamically vary across analysis epochs and/or timesteps based on the number of measurements of interest identified in S200 (e.g., vary as a function of the number of measurements of interest).

The measurements are preferably selected from the resultant measurement set (e.g., measurements of interest from S200), but can additionally and/or alternatively be selected from the measurement set (e.g., measurement set from S100), and/or otherwise selected. The measurements can be selected to form: a composited set of measurements, an uncomposited set of measurements, an excluded set of measurements, an unexcluded set of measurements, and/or any other suitable set of measurements. The composited set of measurements is preferably mutually exclusive with the uncomposited set of measurements and/or the filtered-out set of measurements (e.g., optionally filtered out in S200), but can additionally and/or alternatively not be mutually exclusive with the uncomposited set of measurements, be collectively exhaustive (e.g., to form the measurement set, to form the measurements of interest, etc.) with the uncomposited set of measurements and/or the filtered-out set of measurements (e.g., filtered out in S200), not be collectively exhaustive with the uncomposited set of measurements, and/or otherwise related.

The same and/or different set of composited and/or uncomposited measurements can be selected for each analysis model (e.g., from the same set of candidate measurements). In a first example, when different analysis models are trained and/or optimized on different batch sizes, different measurement sets are selected per analysis model and/or batch size. In a second example, different measurement sets are selected for different analysis models (e.g., select measurements based on metadata values specific to that analysis model). In a third example, the same measurement set is selected for all analysis models.

The measurements are preferably selected using a policy model from a policy module 300, but can additionally and/or alternatively be selected using a different model, manually selected by a user, and/or be otherwise selected. The policy model is preferably trained, but can alternatively be untrained.

In a first variant, the measurements can be selected using a policy model. The policy model can be: a neural network (e.g., CNN, DNN, etc.), a random model, leverage heuristics, and/or any other suitable model or methodology.

In a first embodiment, the measurements can be selected randomly using a random model. The random model can be: a truly random model, a pseudorandom model, a quasirandom model, a low discrepancy sequence, and/or any other suitable random model.

In a second embodiment, the measurements can be selected using a set of heuristics. The heuristics can be applied to the metadata values associated with the respective measurement, the measurement value, and/or any other suitable measurement data. The heuristics can be learned, specified by a user, predetermined, and/or otherwise determined. The heuristics can be used: to calculate a composition score and/or probability (e.g., score determined from weighted metadata values, wherein the semantic values can be converted to a binary, discrete, and/or continuous numeric score), to use as a decision tree, and/or otherwise used.

In a first example, the heuristics can specify that measurements having metadata values below a threshold (e.g., activity values below a threshold) should be candidates for composition, while measurements with metadata values above a threshold (e.g., activity values above a threshold) should not be candidates for composition.

In a second example, the heuristics can specify that measurements sampled from a specific sensor system 100 should not be composited and/or measurements sampled from a specific sensor system 100 should be composited.

In a third example, the heuristics can specify that measurements from measurement streams that had a measurement composited in the prior analysis epoch and/or timestep are given a lower score and/or probability of being selected for composition; and/or measurements from measurement streams without previously composited measurements are given a higher score and/or probability of being selected for composition.

In a fourth example, the heuristics can specify that measurements from measurement streams with high security event incidences and/or detection are given a lower score and/or probability of being selected for composition.

In a fifth example, the heuristics can specify that measurements with associated metadata values that deviate from the baseline value (e.g., for the respective metadata parameter) beyond a threshold metric are selected for non-composition. The baseline value can be: predetermined, determined based on historical attribute value occurrence for the measurement stream, and/or otherwise determined.

In a sixth example, the heuristics can specify that measurements from measurement streams that are more recently analyzed at full resolution are given a higher score and/or probability of being selected for composition.

In a seventh example, the heuristics can specify deterministically rotating the composition assignment through the set of measurement streams (e.g., such that all streams receive the same number of composited/uncomposited opportunities over a predetermined period of time).

However, the heuristics can be otherwise used.

In a third embodiment, the measurements can be selected using a neural network model, which determines whether each measurement should be composited. The neural network model can evaluate and/or classify each measurement: serially, as a batch, or in any other suitable order. In a first example, the neural network model classifies each measurement as a measurement to composite or not composite. In a second example, the neural network model scores each measurement, wherein measurements satisfying a score condition can be selected for composition. In this example, the neural network model can score the measurement based on the scene content, the metadata values, and/or other values. In a specific example, a measurement associated with a high-motion scene can be scored with a low composition score (e.g., the measurement should be analyzed at full size or full resolution if possible), while a measurement associated with a low-motion scene can be scored with a high composition score. The measurements can then be ranked, included in a composited set of measurements based on whether the respective score satisfies a score threshold, and/or otherwise selected for composition based on the score.

However, the policy model can be otherwise used.

In a second variant, the measurements can be selected based on the probability of a security event. In this variant, a security event probability can be determined based on the measurement and/or associated metadata, wherein measurements with low security event probabilities can be preferentially selected for composition and/or otherwise handled.

In a third variant, the measurements can be selected based on the scene complexity (e.g., predetermined or determined from the measurement). In this variant, measurements of less complex scenes can be preferentially selected for composition and/or otherwise handled.

In a fourth variant, the measurements can be selected using a score (e.g., affinity score), using an affinity function, using a set of attention layers, and/or otherwise attending to measurements with higher relevancy. The score can be calculated based on: the time since the measurement stream's last uncomposited analysis; the number of active entities detected in the measurement or measurement stream (e.g., people, vehicles, other mobile entities, etc.); the number of high-importance entities (e.g., firearms, weaponry, etc.); the presence or probability of a small object (e.g., with a critical dimension of less than 3 ft, 2 ft, 1 ft, 6 inches, etc.); whether the measurement stream is active (e.g., whether there is change detected in the measurement stream; whether the measurement stream's sensor is turned on, etc.); importance of the measurement stream and/or entity detected therein to a downstream process (e.g., downstream detection model); and/or any other suitable parameters of or extracted from the measurement stream.

However, measurements to composite can be otherwise selected.

### 5.4. Generating Composite Measurements S400.

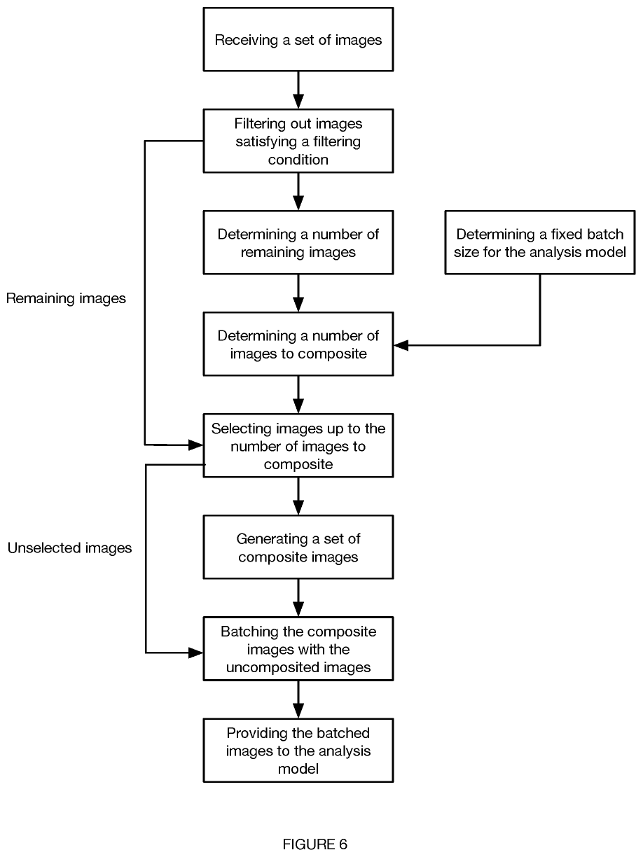

Generating composite measurements S400 can function to composite a subset of the measurements (e.g., from the measurement set of S100, from the measurements of interest of S200, etc.) into composite measurements, while leaving the remaining measurements uncomposited; example shown in FIG. 6. While this reduces the resolution (and possibly detection accuracy) for the composited images, this enables the same, pretrained analysis model to analyze more measurements than the original batch size. In examples, the inventors have discovered that this can be accomplished with minimal (e.g., less than 10%, 5%, 1%, 0.5%, etc.) drop in performance (e.g., accuracy, precision, recall, etc.). S400 is preferably performed after S300, but can additionally and/or alternatively be performed concurrently with S300, before S300, and/or any other suitable time. S500 can be performed by the policy module 300, the analysis module 400, the processing system 500, and/or any other suitable system.

The composite measurement is preferably a synthetic measurement that is created from a set of constituent measurements, but can additionally and/or alternatively be the original measurement. The composite measurement preferably has the same measurement characteristics (e.g., aspect ratio, dimensions, resolution, etc.) as the uncomposited measurements and/or training measurements, but can alternatively have different measurement characteristics as the uncomposited measurements and/or training measurements. For example, when the uncomposited measurements are 1024×768 px, the composited measurement is also 1024×768 px. However, the composite measurement can be otherwise related to the uncomposited measurements, and/or otherwise constructed.

The composite measurement is preferably a grid of downscaled (e.g., reduced resolution) constituent measurements (e.g., examples shown in FIG. 4 and FIG. 5), but can additionally and/or alternatively be a grid of cropped constituent measurements, overlaid constituent measurements, a composited single measurement with key scene features extracted from constituent measurements, and/or be otherwise constructed. The constituent measurements are preferably uniformly downscaled to fit the grid cell size (e.g., maintaining the constituent measurements' relative aspect ratio), but can be additionally and/or alternatively be non-uniformly downscaled, and/or otherwise downscaled. The downscaling (e.g., compression) of constituent measurements is preferably lossless, but can additionally and/or alternatively be lossy. The constituent measurements can be downscaled by resizing the measurement, using a nearest-neighbor interpolation, using a bilinear algorithm, using box sampling, using resampling (e.g., sinc, Lanczos, etc.), using vectorization, using Fourier-transform methods, and/or otherwise downscaling the constituent measurements.

The constituent measurements cooperatively forming a composite measurement are preferably measurements selected in S300 (e.g., examples shown in FIG. 4 and FIG. 5), but can additionally and/or alternatively be measurements received in S100, measurements of interest identified in S200, filler measurements (e.g., with NAN or a predetermined value for each pixel, etc.), and/or any other suitable measurements. Filler measurements can be used to fill a gap in the composite measurement when the number of selected measurements is not a multiple of the composite measurement grid number, and/or otherwise used. The constituent measurements can optionally include padding between spatially adjacent measurements (e.g., adjacent measurements in the collation). Each measurement selected in S300 preferably only appears once in the set of generated composite measurements, but can additionally and/or alternatively appear multiple times in the generated composite measurements, not appear in the generated composite measurements, and/or otherwise constructed. Each composite measurement preferably includes multiple constituent measurements, but can additionally and/or alternatively include a single constituent measurement. The number of constituent measurements can be fixed, unfixed, and/or variable.

The number of constituent measurements per composite measurement (e.g., g) is preferably predetermined, but can alternatively vary across analysis epochs and/or timesteps, based on the number of measurements of interest (C) (e.g., when the number of measurements of interest exceeds the number of potential measurements that could be analyzed, even if all measurements in the batch were composited, or when C>g*B, etc.), based on batch size (B), and/or or otherwise vary. The number of constituent measurements per composite measurement can be calculated as a fraction of: the uncomposited measurement height, width, and/or otherwise calculated. For example, 4, 16, or 32 constituent measurements can be included in a composited measurement.

The measurement identifier can be tracked for each grid cell and/or grid position, such that the analysis result for the grid cell can be traced back to the source sensor system 100, monitored space, and/or monitored scene. However, the measurement identifier can be otherwise tracked.

However, the composite measurements can be otherwise generated.

### 5.5. Analyzing a Batch of Measurements S500.

Analyzing a batch of measurements S500 can function to determine analyses (e.g., security analyses), such as attributes and/or higher-level analyses, from the measurements. S500 is preferably performed after S400, but can additionally and/or alternatively be performed concurrently with S400, before S400, and/or any other suitable time. The batch of measurements preferably includes composited measurements (e.g., from S400) and uncomposited measurements (e.g., the remaining or non-selected measurements from S300; raw measurements from S100; processed measurements from S100; the non-filtered measurements from S200 and non-selected measurements from S300 etc.), but can alternatively include only uncomposited measurements, only composited measurements, reference measurements, and/or any other suitable measurements. The (inference) batch size of the batch of measurements can be a fixed batch size (e.g., a manually-specified batch size, the training batch size, etc.), a batch size selected to minimize accuracy loss and maximize inference speed, a and/or any other suitable batch size. Measurements of the batch can be analyzed: concurrently and/or contemporaneously as a batch, in series, and/or analyzed in any other suitable order. S500 is preferably performed by the analysis module 400 (e.g., an analysis model), but can additionally and/or alternatively be performed by the policy module 300, the filtering module 200, the sensor system 100, and/or any other suitable system.

The analyses can be: security event analyses, change detection analyses, anomaly detection analyses, human pose analyses, object detection analyses, and/or any other suitable analyses.

In examples, S500 can be performed using one or more of the methods disclosed in: U.S. application Ser. No. 16/137,782 filed 21 Sep. 2018; U.S. application Ser. No. 16/816,907 filed 12 Mar. 2020; U.S. application Ser. No. 16/696,682 filed 26 Nov. 2019; and/or U.S. application Ser. No. 16/695,538 filed 26 Nov. 2019; each of which are incorporated in its entirety by this reference.

Each analysis can be associated with: the measurement stream (e.g., from which the underlying measurement(s), used to determine the analysis, were obtained), the sensor system 100 (e.g., that generated the underlying measurements), the monitored space and/or scene (e.g., that the underlying measurement was monitoring, that the underlying measurement depicted, etc.), a timestamp or analysis epoch (e.g., associated with the measurement timestamp), and/or with any other suitable information.

In a first variant, S500 includes determining a set of labels for a measurement (e.g., using a classifier, an object detector, etc.). When the measurement is a full-frame measurement (e.g., uncomposited measurement), the resultant analyses can be associated with the measurement stream, the sensor system 100, the monitored space and/or scene, the measurement timestamp, and/or any other suitable datum associated with the full-frame measurement. When the measurement is a composited measurement, the resultant analyses can be associated with each constituent measurement and/or associated data (e.g., the constituent measurement's: measurement stream, sensor system 100, monitored space and/or scene, timestamp, etc.). Additionally or alternatively, the resultant analysis can trigger subsequent constituent measurement analysis (e.g., individual constituent measurement analysis using the analysis module(s)). For example, the full-frame versions of the constituent measurements can be retrieved and individually analyzed using the analysis module(s) when a predetermined set of analysis values are determined from the composited measurement. However, the analysis labels determined from the composited measurement can be otherwise associated with the underlying constituent measurements. Alternatively, the set of analyses can be associated with any other datum.

In a second variant, S500 includes determining a set of analyses for each set of pixels (e.g., each pixel, each pixel subset, each grid cell, etc.) of a measurement (e.g., using a segmentation model, object detector, etc.). When the measurement is an uncomposited measurement, the set of analyses for all pixels can optionally be summarized (e.g., consolidating duplicate labels; selecting only high-probability labels; etc.) and associated with the measurement stream, the sensor system 100, the monitored space and/or scene, the measurement timestamp, and/or any other suitable datum associated with the uncomposited measurement. When the measurement is a composited measurement, the set of analyses for the set of pixels associated with (e.g., derived from) each constituent measurement can be associated with: the constituent measurement, the constituent measurement's measurement stream, the constituent measurement's sensor system 100, the constituent measurement's monitored space and/or scene, the constituent measurement's measurement timestamp, and/or any other suitable datum associated with the constituent measurement. For example, all labels determined from the upper right quadrant of the composited measurement can be associated with the constituent measurement located in the upper right quadrant. Alternatively, the set of analyses determined from a composited measurement can be associated with all constituent measurement's associated data (e.g., the upper right labels are associated with constituent measurements in all quadrants), or be used as a trigger for further (e.g., individual) constituent measurement analysis. Alternatively, the set of analyses can be associated with any other suitable datum.

In variants, the analyses can optionally be associated with a comparison metric or not be associated with a comparison metric. Examples of the comparison metric can be: accuracy, precision, recall, similarity, speed (e.g., latency), and/or any other suitable metric. The comparison metric preferably compares the determined analyses with a different set of analyses, but can additionally and/or alternatively compare the determined analyses with any other suitable information. The reference set of analyses can include: analyses extracted from full-frame (e.g., uncomposited) versions of the same measurements, a set of training labels determined using a different labeling modality (e.g., manually labeled, labeled using a different model), and/or be otherwise generated.

However, the batch of measurements can be otherwise analyzed.

In variants, the method can include determining a security event based on the set of analyses, which can function to determine whether a security response should be initiated, and/or otherwise used. This can be performed after S500, during a subsequent iteration of the method, and/or at any other suitable time. This can be performed using: the analysis module 400 (e.g., by an analysis model within the analysis module); a security event detection module (e.g., including a single model configured to detect multiple types of security events; including different models for each of a plurality of security events; etc.); and/or any other suitable module. The security event can be determined based on: the analysis for a single analysis epoch (e.g., a single timestep), the analyses for multiple analysis epochs (e.g., the last 5 analysis epochs, last 10 analysis epochs, last hour's worth of analyses, etc.), and/or analyses from any other suitable time frame. The security event can be determined based on: analyses extracted from a single measurement stream; analyses extracted from multiple measurement streams; analyses extracted from measurements of a single monitored space and/or scene (e.g., a single room); analyses extracted from measurements of multiple monitored spaces and/or scenes (e.g., multiple rooms); and/or any other suitable set of measurements.

In a first variant, detecting a security event includes determining that a set of analyses satisfies a predetermined set of conditions. For example, a security event can be detected when a “person holding a gun” is extracted from a measurement stream for more than two consecutive measurements or timesteps. In a second example, a security event can be detected when an “unauthorized person has entered room x”, where room x is associated with a strict authorization requirement. In a third example, a security event can be detected when an attribute value exceeds a baseline attribute value. For example, a security event cannot be detected when a “gun” attribute is extracted form a measurement of a gun shop, where the gun detection occurrence (e.g., the baseline) is very high, but can be detected when a “gun” attribute is extracted from a measurement of a factory, where the gun detection occurrence (e.g., the baseline) is very low.

In a second variant, detecting a security event includes determining a security event label based on the set of analyses using a security event model. The security event model can be trained to determine whether a security event is occurring and/or the security event type based on the set of analyses. The training data set can include: manually-labeled sets of analyses and/or measurements; analysis sets and/or measurement sets associated with security deployments or responses; and/or any other suitable training data.

However, the security event can be detected using the methods discussed in U.S. application Ser. No. 16/137,782 filed 21 Sep. 2018; U.S. application Ser. No. 16/816,907 filed 12 Mar. 2020; U.S. application Ser. No. 16/696,682 filed 26 Nov. 2019; U.S. application Ser. No. 16/695,538 filed 26 Nov. 2019; each of which are incorporated in its entirety by this reference, and/or otherwise detected.

### 5.6. Training a Policy Model S600.

Training a policy model S600 can function to train a policy model from the policy module 300. S600 is preferably performed before S300, but can additionally and/or alternatively be performed concurrently with S300, after S300, and/or any other suitable time. S600 can be performed by: a policy module 300, a processing system 500, a filtering module 200, an analysis module 400, a sensor system 100, and/or any other suitable system. The policy model can be a neural network (e.g., CNN, DNN, etc.), an equation (e.g., weighted equations), a random generator, a regression, classification, rules, heuristics, instance-based methods (e.g., nearest neighbor), regularization methods (e.g., ridge regression), decision trees, Bayesian methods (e.g., Naïve Bayes, Markov, etc.), kernel methods, probability, deterministics, support vectors, and/or any other suitable model or methodology. The policy model is preferably trained using reinforcement learning, but can additionally and/or alternatively be trained using supervised learning, unsupervised learning, semi-supervised learning, and/or any other suitable learning technique.

The policy model can be: trained on a predetermined training set, wherein each training measurement is labeled with a “compose” or “not compose” label (e.g., by passing the full-frame measurement through the analysis module 400 and/or analysis models); trained on the runtime measurements, the learned model composition label, and the analysis model results (e.g., retrained when the analysis model performance drop below a threshold; penalize the runtime measurement-composition label combination when the analysis model performance drops below a threshold; etc.); trained by comparing the analysis results of the composited measurement (e.g., selected for composition using the policy model) and the analysis results of the uncomposited version of the measurement; trained by comparing the analysis results of the batch of measurements (e.g., batch of measurements from S500) and analysis results of the measurement set (e.g., measurement set from S100); trained by comparing the security events detected based on the composited measurement and security events detected based on the uncomposited measurement; and/or otherwise trained. Additionally and/or alternatively, the policy model can be trained using any other suitable training method.

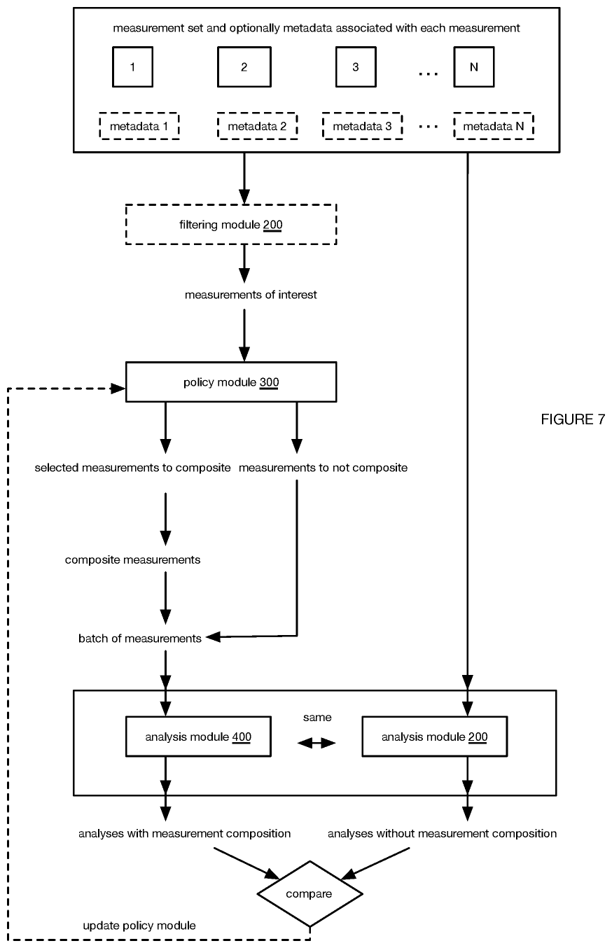

In variants, training the policy model can include: determining test analysis results for the batch of measurements based on the batch of measurements using one or more analysis models of the analysis module 400, wherein the batch of measurements includes composited and uncomposited measurements; determining reference analysis results for the batch of measurements based on the uncomposited versions of all measurements in the batch, using one or more analysis models of the analysis module 400; comparing the test analysis results with the reference analysis results; and updating the one or more policy models based on the comparison (e.g., updating weights, adjusting thresholds and/or conditions, changing which metadata parameters are considered, etc.); example shown in FIG. 7. In another variant, the policy model can be trained such that a dissimilarity between a target set of detected security events, determined based on uncomposited training measurements, and a test set of detected security events, determined based on selectively composited versions of the training measurements, is less than a predetermined threshold; wherein the policy model selects which measurements to composite.

However, the policy model can be otherwise trained.

Different processes and/or elements discussed above can be performed and controlled by the same or different entities. In the latter variants, different subsystems can communicate via: APIs (e.g., using API requests and responses, API keys, etc.), requests (e.g., controlled by authentication and/or authorization credentials), and/or other communication channels.

Alternative embodiments implement the above methods and/or processing modules in non-transitory computer-readable media, storing computer-readable instructions that, when executed by a processing system, cause the processing system to perform the method(s) discussed herein. The instructions can be executed by computer-executable components integrated with the computer-readable medium and/or processing system. The computer-readable medium may include any suitable computer readable media such as RAMs, ROMs, flash memory, EEPROMs, optical devices (CD or DVD), hard drives, floppy drives, non-transitory computer readable media, or any suitable device. The computer-executable component can include a computing system and/or processing system (e.g., including one or more collocated or distributed, remote or local processors) connected to the non-transitory computer-readable medium, such as CPUs, GPUs, TPUS, microprocessors, or ASICs, but the instructions can alternatively or additionally be executed by any suitable dedicated hardware device.

Embodiments of the system and/or method can include every combination and permutation of the various system components and the various method processes, wherein one or more instances of the method and/or processes described herein can be performed asynchronously (e.g., sequentially), concurrently (e.g., in parallel), or in any other suitable order by and/or using one or more instances of the systems, elements, and/or entities described herein.

As a person skilled in the art will recognize from the previous detailed description and from the figures and claims, modifications and changes can be made to the preferred embodiments of the invention without departing from the scope of this invention defined in the following claims.

We claim:

1. A method, comprising:
determining a set of contemporaneous measurements of a set of monitored scenes;
determining metadata for each measurement within the set of measurements, wherein the metadata comprises a set of prior security analyses determined by a set of analysis models for a prior timestep;
using a policy model, determining a composite subset and an uncomposited subset from the set of measurements, based on the respective metadata;
generating a set of composite measurements based on the composite subset;
batching the set of composite measurements and the uncomposited subset into a batch of measurements; and
using the set of analysis models, determining a set of security analyses for a current timestep based on the batch.

2. The method of claim 1, further comprising: determining a filtered subset from the set of measurements using a filtering model, wherein the composite subset and the uncomposited subset each exclude measurements from the filtered subset.

3. The method of claim 2, wherein the filtering model comprises a change detector, wherein the filtered subset comprises measurements with less than a threshold amount of change.

4. The method of claim 1, wherein the composite subset has a predetermined number of measurements.

5. The method of claim 1, wherein the set of measurements comprise N measurements, wherein a batch size of the batch is B measurements, wherein each composite measurement comprises g constituent measurements, and wherein a predetermined number of measurements within the composite subset is determined based on N, B, and g.

6. The method of claim 1, wherein each measurement is sampled by a sensor monitoring the respective monitored scene; wherein the metadata for each measurement is determined based on a set of prior measurements sampled by the respective sensor.

7. The method of claim 1, wherein the set of security analyses comprises a security analysis for each of the set of monitored scenes, wherein the metadata for each measurement comprises a security analysis from a prior timestep for the respective monitored scene.

8. The method of claim 7, wherein the metadata for each measurement is further determined based on a plurality of prior security analyses from a plurality of prior timesteps for the respective monitored scene.

9. The method of claim 8, wherein the metadata for each measurement is determined based on a baseline security analysis, determined based on the respective plurality of prior security analyses, for the respective monitored scene.

10. The method of claim 1, wherein each security analysis is associated with a monitored scene, the method further comprising detecting a security event for a monitored scene based on the associated security analyses.

11. The method of claim 1, wherein the set of analysis models are determined using a fixed batch size for the batch.

12. The method of claim 1, wherein the policy model comprises a lossless affinity function.

13. The method of claim 1, wherein the policy model randomly selects the composite subset.

14. The method of claim 1, wherein the set of analysis models comprises at least one of an object detector, a human pose detector, or an event detector.

15. The method of claim 1, wherein generating the set of composite measurements comprises downscaling each measurement within the composite subset and compositing a predetermined number of scaled-down measurements into a composite measurement having a same size as the full frame measurement.

16. A system for scalable security event monitoring, comprising a processing system configured to:
determine metadata for each measurement within a measurement set;
evaluate whether to composite each measurement based on the respective metadata and a target batch size, using a policy model;
composite the measurements identified for composition; and
determine a security analysis for each measurement within the measurement set based on the composited measurements and a remainder of the measurements from the measurement set, using a set of analysis models optimized using the target batch size.

17. The system of claim 16, wherein the policy model comprises a lossless affinity function.

18. The system of claim 16, wherein each measurement within the measurement set is from a different measurement stream, and wherein the metadata comprises a prior set of security analyses extracted from a prior measurement within the respective measurement stream.

19. The system of claim 16, wherein the measurements within the measurement set are contemporaneously sampled.

20. The system of claim 16, wherein the policy model is trained such that a dissimilarity between a target set of detected security events, determined based on uncomposited training measurements, and a test set of detected security events, determined based on selectively composited versions of the training measurements, is less than a predetermined threshold; wherein the policy model selects which measurements to composite.
